(19) United States
(12) Patent Application Publication
(10) Pub. No.: US 2015/0195817 A1
(43) Pub. Date: Jul. 9, 2015

(54) METHOD OF CONTROL SIGNALING TRANSMISSION AND RECEPTION FOR USER EQUIPMENT IN A LTE COMMUNICATION SYSTEM

(71) Applicant: Satha Sathananthan, Victoria (AU)

(72) Inventor: Satha Sathananthan, Victoria (AU)

(73) Assignee: NEC CORPORATION, Tokyo (JP)

(21) Appl. No.: 14/127,792

(22) PCT Filed: Feb. 4, 2013
(86) PCT No.: PCT/JP2013/053161

§ 371 Date: Dec. 19, 2013

(30) Foreign Application Priority Data
Sep. 24, 2012 (AU) 2012904157

(51) Int. Cl. H04W 72/04

(52) U.S. Cl. CPC H04W 72/042

(57) ABSTRACT

A method implemented in a base station used in a wireless communications system is disclosed. The method includes transmitting, to a user equipment (UE), an indication of a type of enhanced physical downlink control channel (ePDCCH) transmission, where the type of ePDCCH transmission comprises either localized transmission or distributed transmission, and transmitting, to the UE, an indication of the number of physical resource block (PRB) pairs allocated for the ePDCCH transmission, where the indication of the number of PRB pairs allocated for the ePDCCH transmission is conveyed in 2 or 3 bits. Other methods, apparatuses, and systems also are disclosed.

### TECHNICAL FIELD

The invention relates generally to wireless communications, and in particular to methods and apparatus for allocating resources for control signaling transmissions within a wireless network.

### BACKGROUND ART

Widely deployed wireless voice and data communications systems include multiple-access systems capable of supporting communication with multiple users by sharing the available system resources (e.g. bandwidth and transmit power). Examples include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals, i.e. user equipment (UE) apparatus. Each UE receives communications from one or more base stations via a downlink and sends communications back to the base station via an uplink. The communications link may be established via a single-in-single-out (SISO), multiple-in-single-out (MISO) or a multiple-in-multiple-out (MIMO) system.

### CITATION LIST

### Non Patent Literature

NPL 1: 3GPP Radio Layer, [searched on Jan. 24, 2013], internet (URL:http://www.3gpp.org/RAN1-Radio-layer-1)

### SUMMARY OF INVENTION

### Technical Problem

In such systems, a control signaling channel is generally used for allocation of transmission resources to the UEs sharing the wireless radio spectrum, as well as for other configuration, operations and signaling purposes. An example of a control signaling channel is the physical downlink control channel (PDCCH) defined within the 3GPP LTE specifications.

In progressing to more-advanced and higher-capacity wireless multiple-access communication systems, there is a requirement for corresponding enhancements to the control channel capacity and capabilities. In particular, the 3GPP Radio Layer 1 (RAN1) Working Group is developing an enhanced PDCCH (ePDCCH) specification with the following design requirements:
able to support increased control channel capacity;
able to support frequency-domain inter-cell interference coordination (ICIC);
able to achieve improved spatial reuse of control channel resources;
able to support beamforming and/or diversity;
able to operate on new carrier types and in multicast-broadcast single frequency network (MBSFN) subframes;
able to coexist on the same carrier as legacy UEs; and
desirably able to be scheduled frequency-selectively, and to mitigate inter-cell interference.

Some aspects are directed to addressing some of the above requirements for the ePDCCH, within the framework agreed by RAN1. In particular, 3GPP RAN1 has agreed that ePDCCH shall be multiplexed with the physical downlink shared channel (PDSCH) in a pure frequency division multiplexing (FDM) manner, that ePDCCH shall occupy a physical resource block (PRB) pair and shall not be multiplexed with PDSCH within a PRB-pair.

A particular object of some aspects is therefore to provide an effective and efficient method for a base station to provide a PRB indication to a UE, in order to notify the UE of the allocations of PRB-pairs for ePDCCH transmission.

A related problem is that of enabling the UE to identify and demultiplex relevant signaling information received within the ePDCCH. The legacy LTE standards provide for ‘blind decoding’ of signaling by the UE, which conducts a search of a defined PDCCH search space in order to identify signaling intended for the UE. The legacy PDCCH search space design is based on control channel elements (CCE) and aggregation levels (AL). The legacy PDCCH design is a well-proven technique which provides flexible and efficient transmission of control information. It is therefore desirable that an enhanced design for use with the ePDCCH build on the success of the legacy design.

According to an emerging consensus, the ePDCCH is transmitted via an enhanced CCE (eCCE) data structure, or via an aggregation of multiple eCCEs. It is therefore logical that the eCCE be a basic unit of the ePDCCH search space construction. However, it remains to define a search space design in detail, including specifying the composite eCCEs, supported aggregation levels, and procedures enabling blind decoding by the UE of Downlink Control Information (DCI) messages carried within eCCEs.

It is considered desirable that at least the following factors be taken into account in defining a suitable ePDCCH search space:
ability to support antenna port association with eCCE index implicitly defined in the specification;
minimizing blocking probability;
minimizing blind decoding complexity;
ability to scale with number of allocated PRB-pairs for ePDCCH transmission; and
ability to support different numbers of eCCEs within a PRB-pair.

A further object of some aspects is to provide an ePDCCH search space design and associated methods of blind decoding, addressing one or more of the above desirable factors and features.

### Solution to Problem

In an exemplary aspect of the invention, the present invention have been made to solve the problem like this, and an object thereof is to provide a method implemented in a base station, a user equipment (UE) and a wireless communications system; and a base station, a user equipment (UE) and a wireless communications system, capable of improving the control channel capacity and capabilities.

In view of the foregoing, according to an aspect of the present invention, there is provided a method implemented in a base station used in a wireless communications system, the method includes:

transmitting, to a user equipment (UE), an indication of a type of enhanced physical downlink control channel (ePDCCH) transmission, where the type of ePDCCH transmission includes either localized transmission or distributed transmission;

transmitting, to the UE, an indication of the number of physical resource block (PRB) pairs allocated for the ePDCCH transmission, where the indication of the number of PRB pairs allocated for the ePDCCH transmission is conveyed in 2 or 3 bits.

According to another aspect of the present invention, there is provided a method implemented in a user equipment (UE) used in a wireless communications system, the method includes:

receiving, from a base station, an indication of a type of enhanced physical downlink control channel (ePDCCH) transmission, where the type of ePDCCH transmission includes either localized transmission or distributed transmission;

receiving, from the base station, an indication of the number of physical resource block (PRB) pairs allocated for the ePDCCH transmission, where the indication of the number of PRB pairs allocated for the ePDCCH transmission is conveyed in 2 or 3 bits.

According to still another aspect of the present invention, there is provided a method implemented in a wireless communications system, the method includes:

transmitting, from a base station to a user equipment (UE), an indication of a type of enhanced physical downlink control channel (ePDCCH) transmission, where the type of ePDCCH transmission includes either localized transmission or distributed transmission;

transmitting, from the base station to the UE, an indication of the number of physical resource block (PRB) pairs allocated for the ePDCCH transmission, where the indication of the number of PRB pairs allocated for the ePDCCH transmission is conveyed in 2 or 3 bits.

According to still another aspect of the present invention, there is provided a base station used in a wireless communications system, the base station includes:

a transmitter to transmit to a user equipment (UE) an indication of a type of enhanced physical downlink control channel (ePDCCH) transmission, and an indication of the number of physical resource block (PRB) pairs allocated for the ePDCCH transmission,

wherein the type of ePDCCH transmission includes either localized transmission or distributed transmission, and

wherein the indication of the number of PRB pairs allocated for the ePDCCH transmission is conveyed in 2 or 3 bits.

According to still another aspect of the present invention, there is provided a user equipment (UE) used in a wireless communications system, the UE includes:

a receiver to receive from a base station an indication of a type of enhanced physical downlink control channel (ePDCCH) transmission, and an indication of the number of physical resource block (PRB) pairs allocated for the ePDCCH transmission,

wherein the type of ePDCCH transmission includes either localized transmission or distributed transmission, and

wherein the indication of the number of PRB pairs allocated for the ePDCCH transmission is conveyed in 2 or 3 bits.

According to still another aspect of the present invention, there is provided a wireless communications system includes:

a base station to transmit an indication of a type of enhanced physical downlink control channel (ePDCCH) transmission, and an indication of the number of physical resource block (PRB) pairs allocated for the ePDCCH transmission; and

a user equipment (UE) to receive the indication of the type of ePDCCH transmission and the indication of the number of PRB pairs allocated for the ePDCCH transmission,

wherein the type of ePDCCH transmission includes either localized transmission or distributed transmission, and

wherein the indication of the number of PRB pairs allocated for the ePDCCH transmission is conveyed in 2 or 3 bits.

According to still another aspect of the present invention, there is provided a method implemented in a base station used in a wireless communications system, the method includes:

transmitting, to a user equipment (UE), Y_{offset,k}^{LT} and Pₖ^{LT},

where Y_{offset,k}^{LT} is a signaling parameter to determine a second offset Yₖ^{LT} for a location of the physical resource block (PRB) pairs allocated for localized enhanced physical downlink control channel (ePDCCH) transmission in a k-th subframe, and
Pₖ^{LT} is a signaling parameter to indicate the number of PRB pairs allocated for localized ePDCCH transmission in the k-th subframe.

According to still another aspect of the present invention, there is provided a method implemented in a user equipment (UE) used in a wireless communications system, the method includes:

receiving, from a basestation, Y_{offset,k}^{LT} and Pₖ^{LT},

where Y_{offset,k}^{LT} is a signaling parameter to determine a second offset Yₖ^{LT} for a location of the physical resource block (PRB) pairs allocated for localized enhanced physical downlink control channel (ePDCCH) transmission in a k-th subframe, and
Pₖ^{LT} is a signaling parameter to indicate the number of PRB-pairs allocated for localized ePDCCH transmission in the k-th subframe.

According to still another aspect of the present invention, there is provided a method implemented in a wireless communications system, the method includes:

transmitting, from a base station to a user equipment (UE), Y_{offset,k}^{LT} and Pₖ^{LT},

where Y_{offset,k}^{LT} is a signaling parameter to determine a second offset Yₖ^{LT} for a location of the physical resource block (PRB) pairs allocated for localized enhanced physical downlink control channel (ePDCCH) transmission in a k-th subframe, and
Pₖ^{LT} is a signaling parameter to indicate the number of PRB-pairs allocated for localized ePDCCH transmission in the k-th subframe.

According to still another aspect of the present invention, there is provided a base station used in a wireless communications system, the base station includes:

a transmitter to transmit, to a user equipment (UE), Y_{offset,k}^{LT} and Yₖ^{LT},

where Y_{offset,k}^{LT} is a signaling parameter to determine a second offset Yₖ^{LT} for a location of the physical resource block (PRB) pairs allocated for localized enhanced physical downlink control channel (ePDCCH) transmission in a k-th subframe, and
Pₖ^{LT} is a signaling parameter to indicate the number of PRB-pairs allocated for localized ePDCCH transmission in the k-th subframe.

According to still another aspect of the present invention, there is provided a user equipment (UE) used in a wireless communications system, the UE includes:

a receiver to receive, from a basestation, Y_{offset,k}^{LT} and Pₖ^{LT},

where Y_{offset,k}^{LT} is a signaling parameter to determine a second offset Yₖ^{LT} for a location of the physical resource block (PRB) pairs allocated for localized enhanced physical downlink control channel (ePDCCH) transmission in a k-th subframe, and
Pₖ^{LT} is a signaling parameter to indicate the number of PRB-pairs allocated for localized ePDCCH transmission in the k-th subframe.

According to still another aspect of the present invention, there is provided a wireless communications system includes:

a base station to transmit Y_{offset,k}^{LT} and Pₖ^{LT}; and

a user equipment (UE) to receive Y_{offset,k}^{LT} and Pₖ^{LT},

where Y_{offset,k}^{LT} is a signaling parameter to determine a second offset Yₖ^{LT} for a location of the physical resource block (PRB) pairs allocated for localized enhanced physical downlink control channel (ePDCCH) transmission in a k-th subframe, and
Pₖ^{LT} is a signaling parameter to indicate the number of PRB-pairs allocated for localized ePDCCH transmission in the k-th subframe.

According to still another aspect of the present invention, there is provided a method implemented in a base station used in a wireless communications system, the method includes:

transmitting Pₖ^{DT} to a user equipment (UE),

where Pₖ^{DT} is a signaling parameter to indicate the number of physical resource block (PRB) pairs allocated for distributed enhanced physical downlink control channel (ePDCCH) transmission in k-th subframe.

According to still another aspect of the present invention, there is provided a method implemented in a user equipment (UE) used in a wireless communications system, the method includes:

receiving Pₖ^{DT} from a base station,

where Pₖ^{DT} is a signaling parameter to indicate the number of physical resource block (PRB) pairs allocated for distributed enhanced physical downlink control channel (ePDCCH) transmission in k-th subframe.

According to still another aspect of the present invention, there is provided a method implemented in a wireless communications system, the method includes:

transmitting Pₖ^{DT} from a base station to a user equipment (UE),

where Pₖ^{DT} is a signaling parameter to indicate the number of physical resource block (PRB) pairs allocated for distributed enhanced physical downlink control channel (ePDCCH) transmission in k-th subframe.

According to still another aspect of the present invention, there is provided a base station used in a wireless communications system, the base station includes:

a transmitter to transmit Pₖ^{DT} to a user equipment (UE),

where Pₖ^{DT} is a signaling parameter to indicate the number of physical resource block (PRB) pairs allocated for distributed enhanced physical downlink control channel (ePDCCH) transmission in k-th subframe.

According to still another aspect of the present invention, there is provided a user equipment (UE) used in a wireless communications system, the UE includes:

a receiver to receive Pₖ^{DT} from a base station,

where Pₖ^{DT} is a signaling parameter to indicate the number of physical resource block (PRB) pairs allocated for distributed enhanced physical downlink control channel (ePDCCH) transmission in k-th subframe.

According to still another aspect of the present invention, there is provided a wireless communications system includes:

a base station to transmit Pₖ^{DT}; and

a user equipment (UE) to receive Pₖ^{DT},

where Pₖ^{DT} is a signaling parameter to indicate the number of physical resource block (PRB) pairs allocated for distributed enhanced physical downlink control channel (ePDCCH) transmission in k-th subframe.

One aspect provides a method for identifying resources allocated for enhanced Physical Downlink Control Channel (ePDCCH) transmissions from a base station, the method includes:

reserving resources for ePDCCH transmissions from within resources generally configured for Physical Downlink Shared Channel (PDSCH) transmissions, wherein the reserved resources are characterised by a position within a radio transmission data unit and a quantity of the reserved resources; and

transmitting information indicative of the position within the radio transmission data unit and/or information indicative of the quantity of the reserved resources to a User Equipment (UE) apparatus via a predetermined signaling mechanism.

In embodiments, the radio transmission data unit is a subframe, and the resources reserved for ePDCCH transmission include one or more Physical Resource Block (PRB) pairs within the subframe. The resources reserved for ePDCCH transmission may include at least two PRB pairs occupying adjacent groups of frequency subcarriers within the subframe.

Information indicative of the position within the subframe may include information indicative of an offset value, and information indicative of the quantity of the reserved resources includes information indicative of a number of the reserved PRB pairs. The information indicative of an offset value may identify an initial PRB pair of the at least two PRB pairs. In some embodiments, the information indicative of an offset value includes a dynamic offset value, e.g. a position of the initial PRB pair relative to a predetermined static offset value within the subframe, which identifies a position of the initial PRB pair within the subframe. A static offset value may be predetermined to provide Inter-Cell Interference Coordination (ICIC) with one or more neighbouring radio cells.

In some embodiments, resources reserved for ePDCCH transmission include at least two PRB pairs occupying non-adjacent groups of frequency subcarriers within the subframe. A predetermined frequency subcarrier interval may be provided between successive PRB pairs of the at least two PRB pairs. In some embodiments, the predetermined frequency subcarrier interval may be a uniform frequency interval. Information indicative of the quantity of the reserved resources may include information indicative of a number of the reserved PRB pairs. The reserved resources may be characterised by the position within the subframe of an initial pair of the at least two PRB pairs, which in some embodiments can be a predetermined static offset value within the subframe selected to provide ICIC with one or more neighbouring radio cells.

In some embodiments, the predetermined signaling mechanism includes a Downlink Control Information (DCI) message transmitted in a common search space of a legacy PDCCH channel. Alternatively, the predetermined signaling mechanism may include a message transmitted via an enhanced implementation of a Physical Control Format Indicator Channel (PCFICH). The predetermined signaling mechanism may also, or instead, include Radio Resource Control (RRC) signaling.

In embodiments, the step of reserving the resources for ePDCCH transmissions may include reserving resources in accordance with a selected reservation scheme within a predetermined configuration table.

Another aspect provides an apparatus at a base station configured to identify resources allocated for enhanced Physical Downlink Control Channel (ePDCCH) transmissions, the apparatus includes:

a resource reservation processor configured for reserving resources for ePDCCH transmissions from within resources generally configured for Physical Downlink Shared Channel (PDSCH) transmissions, wherein the reserved resources are characterised by a position within a radio transmission data unit and a quantity of the reserved resources;

a resource reservation signaling processor configured to construct a message including information indicative of the position within the radio transmission data unit and/or information indicative of the quantity of the reserved resources to a User Equipment (UE) apparatus via a predetermined signaling mechanism; and

a transmitter for transmitting the message constructed by the resource reservation signaling processor.

The radio transmission data unit may be a subframe, and the resource reservation processor may be configured to reserve resources of ePDCCH transmissions which include one or more Physical Resource Block (PRB) pairs within the subframe.

In some embodiments, the resources reserved for ePDCCH transmission include at least two PRB pairs occupying adjacent groups of frequency subcarriers within the subframe, and the resource reservation signaling processor is configured to construct a message including information indicative of an offset value of an initial PRB pair of the at least two PRB pairs, and information indicative of a number of the reserved PRB pairs.

In some embodiments, the resources reserved for ePDCCH transmission include at least two PRB pairs occupying non-adjacent groups of frequency subcarriers within the subframe, and the resource reservation signaling processor is configured to construct a message including information indicative of a number of the reserved PRB pairs.

The resources reserved for ePDCCH transmission may include at least two PRB pairs occupying adjacent groups of frequency subcarriers within the subframe, and at least two PRB pairs occupying non-adjacent groups of frequency subcarriers within the subframe, and wherein the resource reservation signaling processor is configured to construct a message includes:

information indicative of an offset value of an initial PRB pair of the PRB pairs occupying adjacent groups of frequency subcarriers;

information indicative of a number of the PRB pairs occupying adjacent groups of frequency subcarriers; and

information indicative of a number of the PRB pairs occupying non-adjacent groups of frequency subcarriers.

In some embodiments, the transmitter is configured to transmit the message constructed by the resource reservation signaling processor within a Downlink Control Information (DCI) message transmitted in a common search space of a legacy PDCCH channel. Alternatively, the transmitter may be configured to transmit the message constructed by the resource reservation signaling processor via an enhanced implementation of a Physical Control Format Indicator channel (PCFICH). As a further option, the transmitter may be configured to transmit the message constructed by the resource reservation signaling processor via Radio Resource Control (RRC) signaling.

The apparatus may further includes a memory storing a configuration table including predefined resource reservations for ePDCCH transmissions, wherein the resource reservation signaling processor is configured to construct a message including information indicative of an entry within the configuration table corresponding with a selected resource reservation.

Another aspect provides a User Equipment (UE) apparatus adapted to locate resources allocated within a radio transmission data unit for enhanced Physical Downlink Control Channel (ePDCCH) transmissions, the UE apparatus includes:

a receiver configured to receive, via a predetermined signaling mechanism, a message including information indicative of a position within the radio transmission unit of the resources allocated for ePDCCH transmissions, and a quantity of the reserved resources; and

a resource location processor configured to locate the resources reserved for ePDCCH transmissions from within resources generally configured for Physical Downlink Shared Channel (PDCCH) transmissions within the radio transmission data unit, in accordance with the information in the received message.

In embodiments, the radio transmission data unit is a subframe, and the resources reserved for ePDCCH transmission include one or more PRB pairs within the subframe, and the resource location processor is configured to locate the reserved PRB pairs within the subframe.

The resources reserved for ePDCCH transmission may include at least two PRB pairs, which may occupy adjacent groups of frequency subcarriers within the subframe, and/or may occupy non-adjacent groups of frequency subcarriers within the subframe.

In embodiments, the receiver is configured to receive resource allocation signaling messages via a predetermined signaling mechanism including one or more of:

a Downlink Control Information (DCI) message transmitted in a common search space of a legacy PDCCH channel;

a message transmitted via an enhanced implementation of a Physical Control Format Indicator Channel (PCFICH); and

a message transmitted via Radio Resource Control (RRC) signaling.

The UE apparatus may further include a memory for storing a configuration table including predefined resource reservations for ePDCCH transmissions, wherein:

the receiver is configured to receive a message including information indicative of an entry within the configuration table; and

the resource location processor is configured to locate the resources reserved of ePDCCH transmissions based upon the contents of the entry in the configuration table corresponding with the information in the received message.

Another aspect provides a method in a wireless device includes:

receiving, at the wireless device, a signal subframe transmitted by a wireless base station;

identifying, by the wireless device, within a data region of the received subframe, a plurality of control channel structures, each including a portion of a control channel;

constructing, by the wireless device, a composite control channel structure, including a concatenation of the control channel structures; and

conducting, by the wireless device, a search over a predetermined search space of the composite control channel structure, to determine a presence of a control information structure including control information directed to the wireless device,

wherein the predetermined search space is selected from a set of search spaces constructed so as to provide scalability with a number of the control channel structures, in combination with a low blocking probability of access to the control information structure due to contention with other wireless devices.

In embodiments, the method further includes decoding, by the wireless device, of contents of the control information structure.

The predetermined search space may be selected from the set of search spaces according to an algorithm which depends upon one or more of a wireless device identifier, a wireless base station identifier, and a subframe index. In embodiments, the predetermined search space corresponds with an associated antenna port of the wireless device.

The predetermined search space may include a plurality of aggregation levels, which may be selected from a group including one, two, four and eight.

In embodiments, the plurality of control channel structures is transmitted within the signal subframe via one or more Physical Resource Block (PRB) pairs.

The one or more PRB pairs may include a single PRB pair, the plurality of control channel structures may include two control channel structures, and the predetermined search space may include one or two aggregation levels. Alternatively, the plurality of control channel structures may include four control channel structures, and the predetermined search space may include one, two or four aggregation levels.

The one or more PRB pairs may include a plurality of PRB pairs, the plurality of control channel structures may include two control channel structures and the predetermined search space may include one, two or four aggregation levels. Alternatively, the plurality of control channel structures may include four control channel structures, and the predetermined search space may include one, two, four or eight aggregation levels.

In some embodiments, the predetermined search space is selected from the set of search spaces according to an algorithm defined by the iterative equation:

Yₖ={(AYₖ₋₁)mod D} mod N_{eCCE}

wherein N_{eCCE} is a number of the plurality of control channel structures, k is a subframe index, Yₖ mod N_{eCCE} is an index determining the selected search space, A and D are parameters selected such that Yₖ represents a pseudo-random sequence with desired spectral properties, and Y₋₁ is a seed value derived from one or more of a wireless device identifier and a wireless base station identifier.

The one or more PRB pairs may include at least two PRB pairs occupying adjacent groups of frequency subcarriers within the subframe, or may include at least two PRB pairs occupying non-adjacent groups of frequency subcarriers within the subframe. There may be a uniform predetermined frequency subcarrier interval between successive PRB pairs of the at least two PRB pairs.

Yet another aspect provides a wireless User Equipment (UE) apparatus includes:

a receiver, operable to receive a signal subframe transmitted by a wireless base station;

a communications processor operably associated with the receiver and configured to:
identify, within a data region of the received subframe, a plurality of control channel structures, each including a portion of a control channel;
construct a composite control channel structure, including a concatenation of the control channel structures; and
conduct a search over a predetermined search space of the composite control channel structure, to determine a presence of a control information structure including control information directed to the wireless device,
wherein the predetermined search space is selected from a set of search spaces constructed so as to provide scalability with a number of the control channel structures, in combination with a low blocking probability of access to the control information structure due to contention with other wireless devices.

In embodiments, the communications processor is further configured to decode contents of the control information structure.

The communications processor may be configured to select the predetermined search space from the set of search spaces according to an algorithm which depends upon one or more of a wireless device identifier, a wireless base station identifier, and a subframe index.

Embodiments of the wireless UE apparatus further include a plurality of antenna ports, wherein the communications processor is configured to associate the predetermined search space with one of the antenna ports.

A still further aspect provides an apparatus in a wireless base station for communicating with a plurality of wireless devices, the apparatus includes:

a transmitter, operable to transmit a signal subframe to the wireless device;

a communications processor operably associated with the transmitter and configured to:
construct a composite control channel structure consisting of a plurality of concatenated control channel structures including a predetermined search space selected from a set of search spaces, the search space including one or more control information structures directed to one or more of the plurality of wireless devices;
construct, within a data region of the transmitted subframe, a plurality of control channel structures, each including a portion of the composite control channel structure; and
transmit the signal subframe including the control channel structures to one or more of the plurality of wireless devices,
wherein the set of search spaces is constructed so as to provide scalability with a number of the control channel structures, in combination with a low blocking probability of access to the control information structure due to contention between the plurality of wireless devices.

The communications processor may be configured to select the predetermined search space from the set of search spaces according to an algorithm which depends upon one or more of a destination wireless device identifier, a wireless base station identifier, and a subframe index.

The plurality of wireless devices may each include a plurality of antenna ports, wherein the communications processor is configured to associate the predetermined search space with one of the antenna ports of a destination wireless device, and to operate the transmitter to direct transmission of the signal subframe to the associated antenna port.

Further features, benefits and advantages of the invention will be apparent to the skilled person from the following description of embodiments, which is provided by way of example only, and should not be understood to limit the scope of the invention as defined in any of the preceding statements, or in the attached claims.

### Advantageous Effects of Invention

According to the Invention, one or more of the above-mentioned problems is/are ameliorated or overcome.

### BRIEF DESCRIPTION OF DRAWINGS

Embodiments and reference examples will now be described with reference to the accompanying drawings, in which like reference numerals refer to like features, and wherein:

FIG. 1 is a schematic diagram illustrating an exemplary wireless communications system supporting signaling and data transmissions between an enhanced Node B (eNB) base station and an LTE-based User Equipment (UE) 104;

FIG. 2 is a schematic diagram illustrating indications of ePDCCH PRB-pairs;

FIG. 3 is a schematic diagram illustrating two types of ePDCCH resources satisfying requirements for localized and distributed ePDCCH transmission;

FIG. 4 shows an example of frequency domain ICIC for ePDCCH;

FIG. 5 illustrates a generalized signaling structure;

FIG. 6 illustrates simplified signaling;

FIG. 7 is a schematic diagram illustrating determination of localized ePDCCH transmission;

FIG. 8 is a schematic diagram illustrating determination of distributed ePDCCH transmission;

FIG. 9 is a flowchart illustrating overall procedures of ePDCCH transmission;

FIG. 10 illustrates an ePDCCH search space design;

FIG. 11 illustrates another ePDCCH search space design; and

FIG. 12 is a flowchart illustrating a control signaling process within a wireless network, including blind decoding of a DCI within an ePDCCH by a UE.

### DESCRIPTION OF EMBODIMENTS

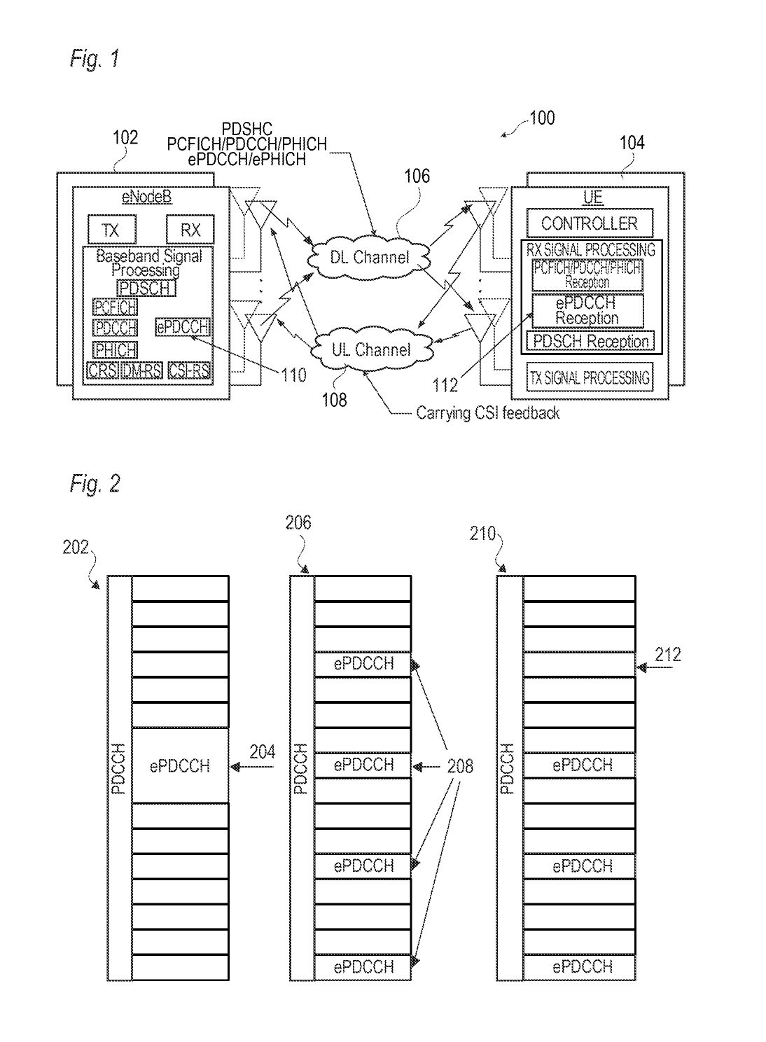

FIG. 1 is a schematic diagram 100 illustrating an exemplary wireless communications system supporting signaling and data transmissions between an enhanced Node B (eNB) base station 102 and an LTE-based User Equipment (UE) 104. Transmissions from the eNB 102 to the UE 104 are via a downlink (DL) channel 106, while transmission from the UE 104 to the eNB 102 are via an uplink (UL) channel 108, generally in accordance with LTE methods as specified within 3GPP specifications.

The eNB 102 and UE 104 include hardware and/or software processing entities 110, 112 configured to implement allocation, transmission and reception of an enhanced Physical Downlink Control Channel (ePDCCH) which is multiplexed in a pure FDM manner with a Physical Downlink Shared Channel (PDSCH) in a data region of transmitted LTE subframes. As will be appreciated, this multiplexing includes allocating resources which are generally configured for the PDSCH, to be used instead for ePDCCH transmissions.

The ePDCCH resources are reserved by the ePDCCH entity 110 of the eNB 102, which is able to select the best PRB resources based on channel state information (CSI), e.g. to improve ePDCCH performance by frequency-selective scheduling gain. This is particularly advantageous for a localized allocation scheme 202, in which effects such as frequency-selective fading may have an especially adverse impact on ePDCCH performance.

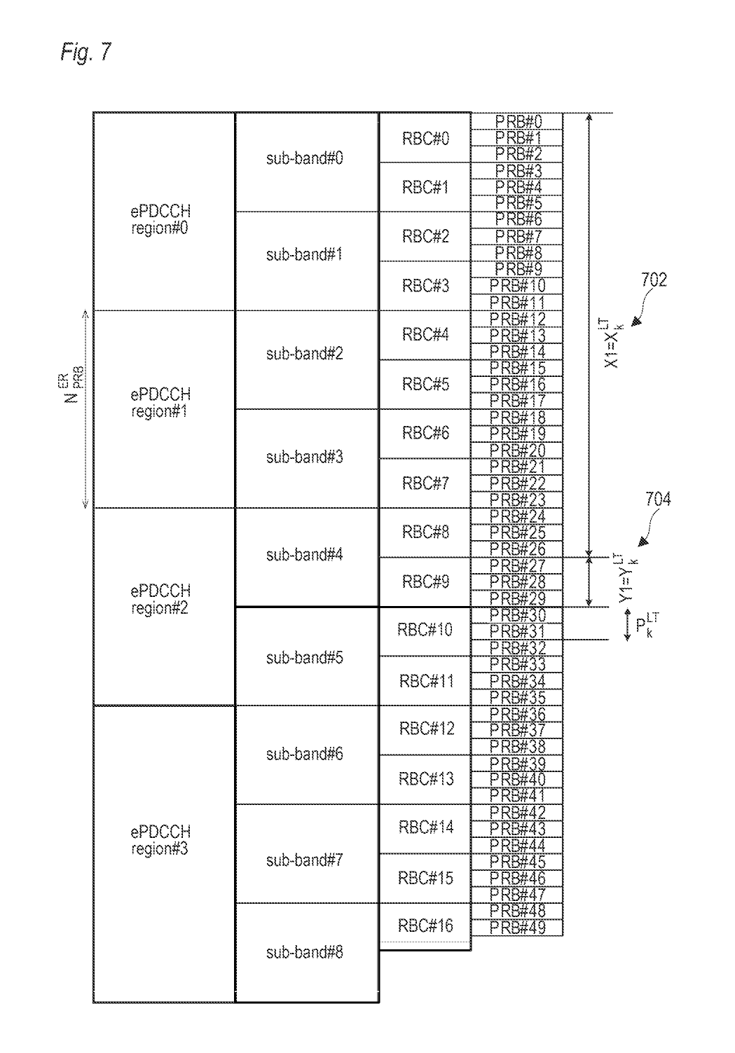

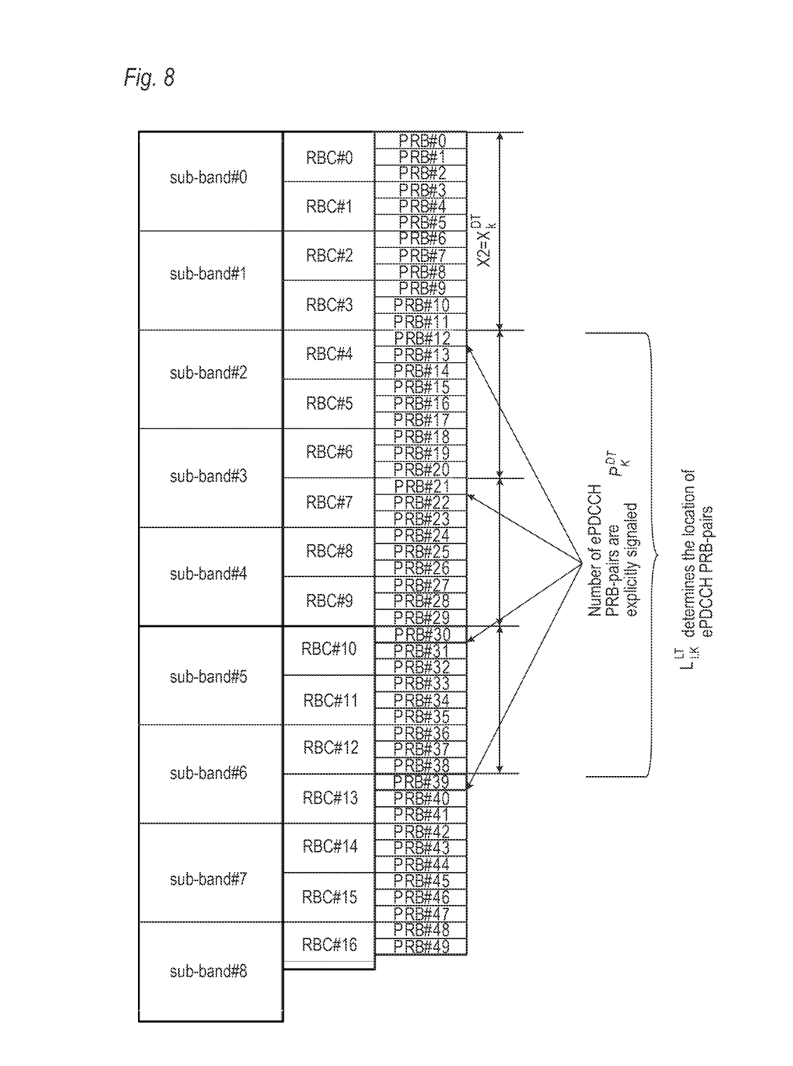

Accordingly, a signaling mechanism is required in order to communicate the ePDCCH resource allocations from the eNB 102 to a UE 104. Desirably, a signaling mechanism will enable allocations to change between subframes. A suitable design of a signaling mechanism will now be described with reference to FIGS. 7 and 8.

### REFERENCE EXAMPLES

It is proposed that the ePDCCH be transmitted within Physical Resource Block (PRB) pairs, which may be allocated according to either a localized or distributed scheme as illustrated in FIG. 2. In a localized allocation scheme 202, the ePDCCH PRB-pairs are reserved in a contiguous block 204 of adjacent groups of frequency subcarriers within the subframe, while in a distributed allocation scheme 206, the ePDCCH PRB pairs are reserved in non-adjacent groups 208 of frequency subcarriers within the subframe. In an example, the non-adjacent groups 208 are spaced apart by a predetermined subcarrier frequency interval. This may be, for example, a uniform frequency interval, or a non-uniform interval.

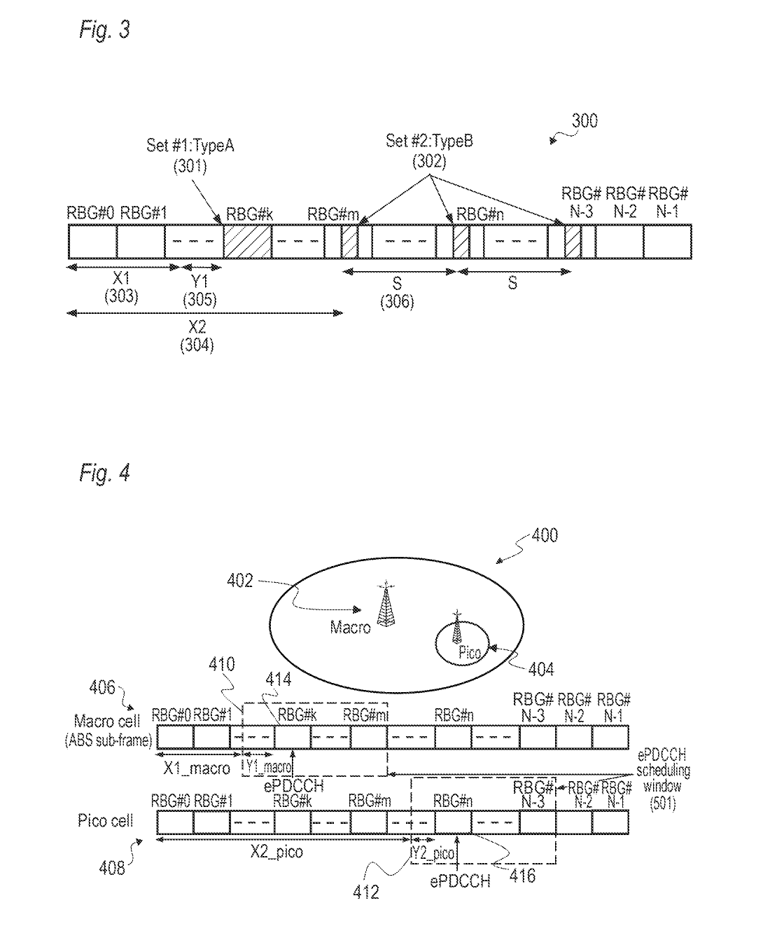

Additionally, as illustrated in the allocation scheme 210, reserved but unused ePDCCH resources, such as PRB-pairs 212, may be used instead for PDSCH transmissions, such as transmissions based on legacy resource allocation schemes (e.g. Type 0, Type 1 and Type 2). FIG. 3 is a schematic diagram 300 illustrating two types of ePDCCH resources satisfying the above requirements for localized and distributed ePDCCH transmission:
Type A resources 301 for localized transmission, defined in terms of number of PRB-pairs allocated; and
Type B resources 302 for distributed transmission, defined in terms of number of PRB-pairs allocated and the predetermined spacing between them.

According to this example, the locations of ePDCCH PRBs are determined by parameters X1/Y1 303/305 (for Type A 301) and X2 304 (for Type B 302).

The parameters X1/X2 303/304 define an offset within the subframe, which could be adapted, for example, to provide frequency domain inter-cell interference control (ICIC) among neighbouring cells for ePDCCH.

An exemplary frequency domain ICIC for ePDCCH is illustrated in FIG. 4, for a HetNet deployment scenario 400 in which a pico-cell 404 is deployed within a macro-cell 402 configured with an Almost Blank Subframe (ABS) 406. The pico-cell 404 is configured with subframe 408. The macro- and pico-cell subframes 406, 408 each have allocated an ePDCCH scheduling window 410, 412. These windows 410, 412 are non-overlapping to minimise ICIC, and their offsets within the subframes 406, 408 are specified by parameters X1_macro and X2_pico respectively.

Within the ePDCCH scheduling windows 410, 412, the Type A PRB-pair groups 414, 416 reserved for the respective ePDCCH allocations are identified by the further offset parameters Y1_macro and Y2_pico. these parameters may be varies by the macro and pico eNBs according to requirements, without concern of increased ICIC between the cells.

In examples, the parameters X1 and X2 may be defined based on Cell_ID and/or subframe index. Furthermore, X1 and X2 could be same for Type A and Type B allocations if Type A and Type B are transmitted in the same PRB-pairs and both are defined based on Cell_ID and/or subframe index. According to some examples, X1 and X2 are defined as an offset number of PRBs. In examples, offset parameter Y1 305 determines an exact location of a first PRB-pair used for ePDCCH (Type A 301) when used in combination with offset X1. The parameter Y1 may be communicated via a signaling parameter (e.g. Yoffset). According to some examples, Y1 is defined as an offset number of PRBs.

Only one PRB-pair is defined within a Resource Block Group (RBG) for Type B resource allocations 302. The location of this PRB-pair within this RBG may be defined, for example, by: always using the lowest PRB index; or on the basis of Cell_ID and/or subframe index.

According to the described example, a predetermined fixed spacing is used between ePDCCH PRB-pairs with Type B allocation 302, as indicated by the parameter S in FIG. 3. The spacing S may be, e.g., implicitly defined in specifications based on system bandwidth, number of allocated PRB-pairs for ePDCCH distributed transmission, and so forth.

FIG. 5 illustrates a generalized signaling structure 500, extending the fixed structure 300, which allows for allocation on only one Type A set 301, and one Type B set 302. According to the generalized scheme, a list of set allocations is defined, each of which may conform to either Type A or Type B. The list contains data structures including:
Set # Type bit 502, indicating whether the set is Type A or Type B; and
Set # indication bits 504, indicating the locations of PRBs allocated for localized or distributed transmission.

The allocation may change dynamically from subframe to subframe. In an example, it includes the following number of bits, which could be dependent on system bandwidth:
Type A:
   2-4 bits: To determine Y1
   2-3 bits: Number of PRB-pairs
Type B:
   2-3 bits: Number of PRB-pairs

This signaling mechanism enables an eNB 102 to dynamically indicate the needed/allocated resources for transmitting both localized and distributed ePDCCH from subframe to subframe.

According to examples, the signaling may be transmitted to the UE 104 by the following methods:
on the legacy PDCCH as new Downlink Control Information (DCI) message in common search space;
on a new physical channel similar to the legacy Physical Control Format Indicator Channel (PCFICH), i.e. enhanced PCFICH (ePCFICH, requires definition); or
if semi-static PRB allocation is adequate, via Radio Resource Control (RRC) signaling.

According to examples, the signaling is transmitted as cell specific or UE specific, and received by UEs 104 supporting ePDCCH features.

In the described example, the entity 112 of the UE 104 is configured to simply assume that if PRB-pairs are indicated for ePDCCH, they are not available for PDSCH transmission. This minimizes reserved ePDCCH resources since only needed ePDCCH resources are indicated. This improves resource utilisation for ePDCCH.

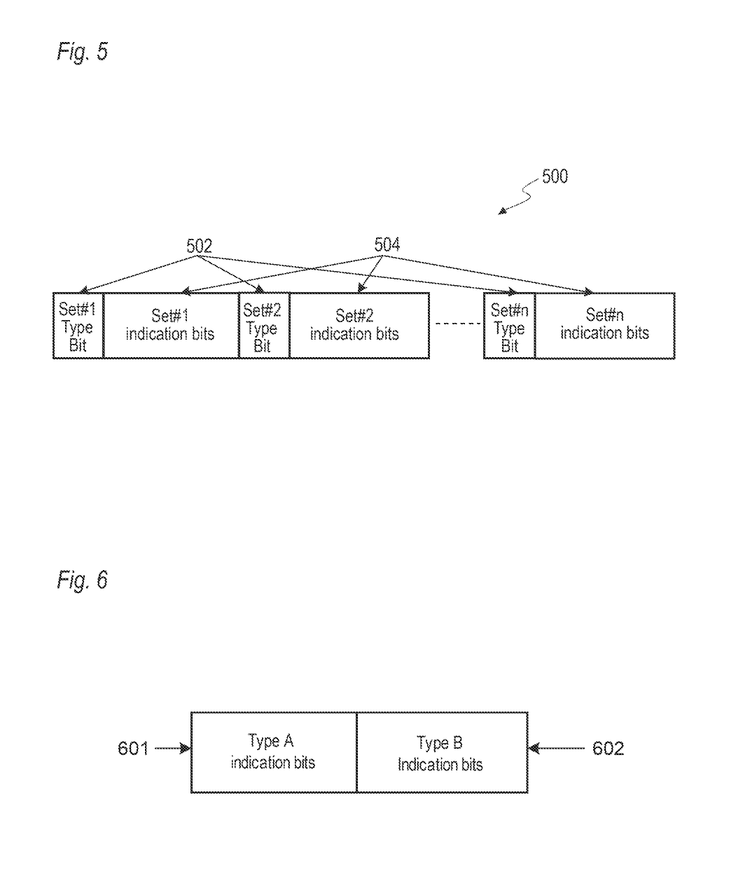

Furthermore, in the described example, If a PRB-pair in the RBG is used for ePDCCH transmission, then the remaining PRB-pairs in the RBG shall be used for PDSCH transmission. The UE 104 may skip the ePDCCH PRB-pairs when decoding PDSCH, since the UE 104 knows which PRB-pairs are allocated for the ePDCCH. This improves resources utilization for PDSCH. FIG. 6 illustrates simplified signaling 600, according to the above-described example, and allocating one set 601 for localized ePDCCH (Type A) transmission and one set 602 for distributed transmission (Type B).

In some examples, reduction of the signaling overhead may be achieved by employing a pre-defined configuration table, e.g. as illustrated in Table 1. This table shows an example of a configuration table for PRB indication to a UE 104 using 5 bits i.e. allowing for a maximum of 32 configurations, wherein 24 configurations are defined and 8 configurations are reserved in this exemplary case. As will be appreciated, the configuration table may be extended in examples, to cover a different number of bits according to system bandwidth.

TABLE 1

| | Localized transmission: | | Distributed | |
|---|---|---|---|---|
| Config | Type A | | Transmission: Type B | |
| # | Y_{offset} | Number of PRBs | Number of PRBs | Note |
| 0 | — | — | 2 | Distributed |
| 1 | — | — | 4 | transmission |
| 2 | — | — | 6 | only |
| 3 | — | — | 8 | |
| 4 | 0 | 1 | 2 | Both local- |
| 5 | 0 | 2 | 4 | ized and |
| 6 | 0 | 3 | 6 | distributed |
| 7 | 0 | 4 | 8 | transmission |
| 8 | 1 | 1 | 2 | |
| 9 | 1 | 2 | 4 | |
| 10 | 1 | 3 | 6 | |
| 11 | 1 | 4 | 8 | |
| 12 | 2 | 1 | 2 | |
| 13 | 2 | 2 | 4 | |
| 14 | 2 | 3 | 6 | |
| 15 | 2 | 4 | 8 | |
| 16 | 3 | 1 | 2 | |
| 17 | 3 | 2 | 4 | |
| 18 | 3 | 3 | 6 | |
| 19 | 3 | 4 | 8 | |
| 20 | 4 | 1 | 2 | |
| 21 | 4 | 2 | 4 | |
| 22 | 4 | 3 | 6 | |
| 23 | 4 | 4 | 8 | |

| | |
|---|---|
| 24-31 | Reserved |

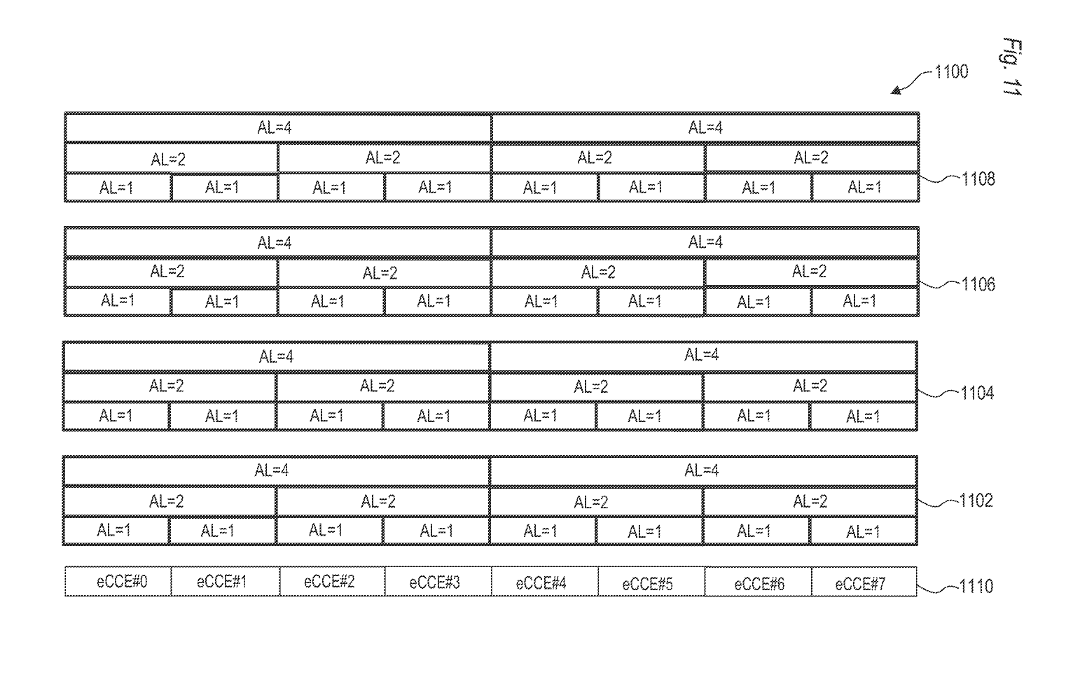

According to examples, the search space for subframe k, with aggregation levels L (defined as Sₖ^{(L)}) is dependent upon UE ID/Cell ID and/or the subframe index. FIG. 10 illustrates search space candidates 1000 for aggregation levels (ALs) of L=1, 2, 4 and 8 for N_{eCCE}=4 while FIG. 11 illustrates search space candidates 1100 for L=1, 2, and 4, for N_{eCCE}=2. In accordance with principles each set of search space candidates 1100, 1200 has been constructed so as to provide scalability with the number of allocated PRB-pairs, in combination with a low blocking probability when different search spaces from the set are in use by different UEs within a single geographic area.

According to examples with N_{eCCE}=4:
aggregation levels 1, 2, 4 and 8 are supported if more than one PRB-pair are used; and
aggregation levels 1, 2 and 4 are supported if one PRB-pair is used.

According to examples with N_{eCCE}=2:
aggregation levels 1, 2 and 4 are supported if more than two PRB-pairs are used; and
aggregation levels 1 and 2 are supported if one PRB-pair is used.

The search spaces 1000, 1100 shown in FIG. 10 and FIG. 11 are designed to support antenna port association with minimal UE implementation complexity, and reduced blocking probability. For example, the four search spaces 1002, 1004, 1006, 1008 for NeCCE=4 and the search spaces 1102, 1104, 1106, 1008 for NeCCE=2, may be selected via a pseudo-random (PR) algorithm based upon subframe number, UE-specific information and/or cell-specific information. Furthermore, each search space may be associated with a specific antenna port, such that the initial eCCE index used for blind decoding is uniquely associated with a corresponding antenna port, in order to simplify UE implementation. Examples having these properties will now be described in greater detail.

In the examples shown in FIGS. 10 and 11, each eCCE within the composite eCCEs is allocated an index, commencing at zero, as shown 1010, 1110 in the lower portion of each chart 1000, 1100. The search space 1002-1008, 1102-1108, along with the corresponding antenna port, defined for each UE within each subframe may be identified according to an algorithm, an example of which is described in greater detail below.

More particularly, according to examples, the search space (Sₖ^{(L)}) shown in FIG. 10 and FIG. 11 has the following properties:
a UE assumes that the same antenna port is used for each aggregation level within a search space, such that the start of eCCE index is same for all aggregation levels;
the start of the eCCE search space index in the composite eCCEs is based on UE ID/Cell ID and/or subframe index, which may be determined in a manner similar to the method used for determining start CCE index in legacy PDCCH;
the start eCCE index takes a value from the set {0, 1, 2, 3} for N_{eCCE}=4 and N_{eCCE}=2; and
the start eCCE index also corresponds to antenna ports #7 to #10 respectively.

By way of example, consider a UE which is configured to monitor a number M(L=1) of ePDCCH at aggregation level L=1 for a subframe k in which NeCCE=4. Further assume, for particularity, that the start eCCE value for this UE in subframe k is Yk=0, corresponding with antenna port #7.

In this example, the candidate eCCE index numbers to be searched by the UE for blind decoding of DCIs are given by the search space Sk(L=1), defined by:

Sk(L=1)=Yk+mP(L=1)+i
where i=0, . . . , L−1 (i.e. I=0 for L=1), m=0, . . . , M^{(L)}−1 and P^{(L)} defines the spacing between the candidate positions for aggregation level L, and is given by:

$${P}^{( L )} = \{ \begin{matrix}4 & for L = 1 and L = 2 \\ 8 & for L = 4 \\ 16 & for L = 8\end{matrix}$$

The above formula also applies for the other aggregation levels L={2, 4, 8} shown in the search space 1002 in FIG. 10. It will be appreciated that similar formulae may also be derived for the remaining search spaces 1004-1008 and 1102-1108 shown in FIGS. 10 and 11. These formulae may be readily implemented within UEs.

As noted above, the parameter Yₖ defines the start of eCCE index or antenna port number and Yₖε{0,1,2,3}. In examples, Yₖ is determined according to a PR algorithm based upon a UE identifier, a cell identifier and/or the subframe index k, in order to distribute the search space allocation uniformly around UEs over space and time. In some examples, the computation of Yk could be based on the approach used for legacy PDCCH described in section 9.1.1 of TS36.213, according to which Yₖ is expressed as:

Yₖ={(AYₖ₋₁)mod D} mod N_{eCCE}
where Y₋₁=n_{RNTI}≠, A=39827, D=65537 and, k is the subframe number. As will be appreciated, this formula generates a PR number sequence seeded by a Radio Network Temporary Identifier (RNTI) value associated with the UE, n_{RNTI}, for example as defined in TS36.213.

Furthermore, the specific algorithm described by way of example in relation to the search space 1002 is for illustrative purposes only. More generally, suitable sets of search spaces 1000, 1100 are illustrated in FIGS. 10 and 11, while even more generally these search spaces are themselves illustrative of the principle, which is to provide scalability of the search space with the number of allocated PRB-pairs, in combination with a low blocking probability at each UE.

### EMBODIMENTS

The configuration table may be extended in embodiments, to support either localized ePDCCH transmission, as illustrated in Table 2, or distributed ePDCCH transmission, as illustrated in Table 3.

TABLE 2

| | |
|---|---|
| | Localized transmission: |
| Config | Type A |

| # | Y_{offset} | Number of PRBs |
|---|---|---|
| 0 | 0 | 1 |
| 1 | 0 | 2 |
| 2 | 0 | 3 |
| 3 | 0 | 4 |
| 4 | 1 | 1 |
| 5 | 1 | 2 |
| 6 | 1 | 3 |
| 7 | 1 | 4 |
| 8 | 2 | 1 |
| 9 | 2 | 2 |
| 10 | 2 | 3 |
| 11 | 2 | 4 |
| 12 | 3 | 1 |
| 13 | 3 | 2 |
| 14 | 3 | 3 |
| 15 | 3 | 4 |

TABLE 3

| | Distributed |
|---|---|
| Config | Transmission: Type B |
| # | Number of PRBs |
| 0 | 2 |
| 1 | 3 |
| 2 | 4 |
| 3 | 5 |
| 4 | 6 |
| 5 | 7 |
| 6 | 8 |
| 7 | Reserved |

The tables, e.g. as exemplified by Tables 2 and 3, can be stored in memory of the eNB 102 and UE 104, such that a record corresponding with the configuration may be identified by a table indexing or look-up procedure.

According to some embodiments, the ePDCCH PRB-pairs may be determined from signaling contents as described below, wherein the following parameters are defined:
N_{RB}^{DL}: Number of PRBs defined for downlink bandwidth configuration (or system bandwidth)
   N_{ID}^{cell}: Physical layer cell identity or virtual cell identity
Pₖ^{LT}: Signaling parameter to indicate number of PRB-pairs allocated for localized ePDCCH transmission in k-th subframe
Pₖ^{DT}: Signaling parameter to indicate number of PRB-pairs allocated for distributed ePDCCH transmission in k-th subframe
Xₖ^{LT}: 1st offset to determine the location of localized ePDCCH PRB-pairs
Yₖ^{LT}: 2nd offset to determine the location of localized ePDCCH PRB-pairs
Y_{offset,k}^{LT}: Signaling parameter to determine offset Yₖ^{LT} for the location of localized ePDCCH PRBs
Xₖ^{DT}: Offset to determine the location of distributed ePDCCH PRB-pairs

Determination of localized ePDCCH transmission (Type A) is illustrated in FIG. 7. The location of the PRB-pairs for localized ePDCCH transmission in k-th subframe is given by:

L_{i,k}^{LT}=Xₖ^{LT}+Yₖ^{LT}+i
where i=0, . . . , Pₖ^{LT}−1

and Xₖ^{LT} and Yₖ^{LT} 702, 704 are given by:

Xₖ^{LT}=(N_{ID}^{cell}+k)mod N_{PRB}^{ER}

Yₖ^{LT}=Y_{offset,k}^{LT}N_{PRB}^{ER}
where 0≦Y_{offset,k}^{LT}<N_{ER}−1 and Pₖ^{LT}<N_{PRB}^{ER}

It will be appreciated that the calculation methods for Xₖ^{LT} and Yₖ^{LT} are interchangeable. Furthermore, in this embodiment N_{PRB}^{ER} denotes the size of the ePDCCH region in terms of PRBs, and may be based either on the system bandwidth, or be defined as a predetermined fixed value for all system bandwidths. For example, N_{PRB}^{ER} could be defined as either a sub-band size or twice the sub-band size defined for CSI reporting mode PUSCH 3-1.

Table 4 illustrates an exemplary implementation for defining N_{PRB}^{ER}. Then N_{ER} is the number of ePDCCH regions, given by:

$${N}_{ER} = ⌊ \frac{{N}_{PRB}^{DL}}{{N}_{PRB}^{ER}} ⌋$$

TABLE 4

| System Bandwidth N_{RE}^{DL} | N_{PRB}^{ER} |
|---|---|
| 6 | 2 |
| 15 | 4 |
| 25 | 4 |
| 50 | 6 |
| 75 | 8 |
| 100 | 8 |

In summary, in this embodiment:
the parameters signaled to UE are: Y_{offset,k}^{LT} and Pₖ^{LT};
the parameters defined in the specifications are: N_{PRB}^{ER} and N_{ER}; and
the ePDCCH PRB-pair locations for Type A are calculated as described above.

Determination of distributed ePDCCH transmission (Type B) is illustrated in FIG. 8 in an embodiment in which a uniform frequency spacing is employed. The location of the PRB-pairs for distributed ePDCCH transmission in the k-th subframe is given in this embodiment by:

$${L}_{i , k}^{DT} = \{ \begin{matrix}{X}_{k}^{DT} & for i = 0 \\ {X}_{k}^{DT} + i ⌊ ( \frac{{N}_{RB}^{DL} - {X}_{k}^{DT}}{{P}_{k}^{DT}} ) ⌋ & for i \neq 0\end{matrix}$$

where i=0, . . . , Pₖ^{LT}−1

and Xₖ^{DT} is given by one of the following options:

Xₖ^{DT}=(N_{ID}^{cell}+k)mod N_{cons}

where N_{cons} is a fixed value defined in the specification to provide non-overlapping distributed ePDCCH transmission among neighbor cells and 0≦N_{cons}<<N_{PRB}^{DL}.

In summary, in this embodiment:
the parameter signaled to UE is: Pₖ^{DT};
the parameter defined in the specifications is: N_{cons}; and
the ePDCCH PRB-pair locations for Type B are calculated as described above.

In some embodiments, one of the dynamic configurations as defined, for example, in Table 3 may be used for resource allocations for common search space within the ePDCCH. In such embodiments, one of the following methods could be considered to determine the configuration by the UE:
information used to indicate the relevant configuration may include a cell ID and/or subframe index, mapped to a predetermined configuration (e.g. table entry) as defined in the specifications; and/or
information used to indicate the relevant configuration may be broadcast as an “additional parameter” (TS36.331 section 6.2.2) in a Master Information Block (MIB) message, wherein the UE is configured to use this as a cell specific parameter to access the cell. This shall be done by including the configuration value message.

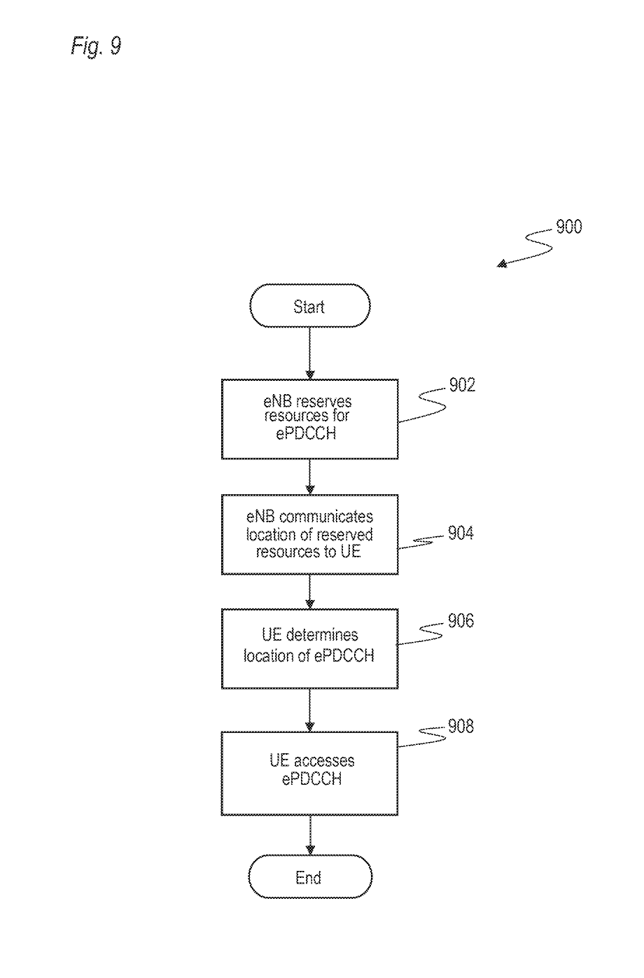

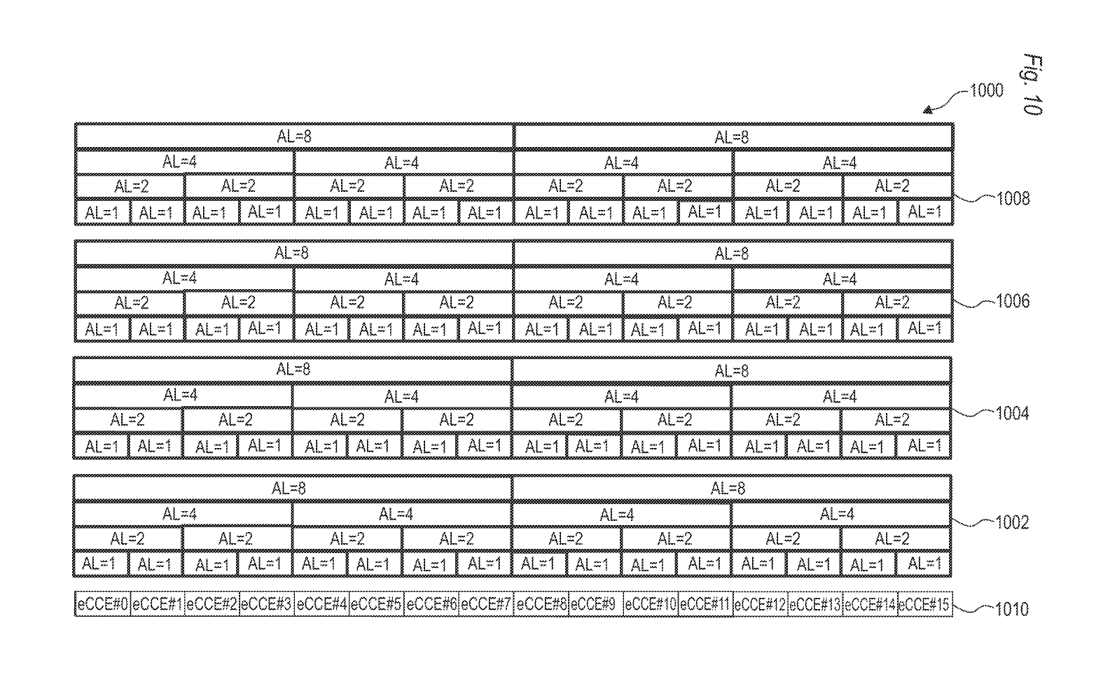

The overall procedures embodying this aspect are further illustrated by the flowchart in FIG. 9.

In particular, the flowchart 900 illustrates a method as conducted by a wireless base station (i.e. eNB) in communication with a wireless device (i.e. UE). At step 902 the eNB reserves resources, i.e. PRB-pairs, within the data region of a subframe for ePDCCH allocation. At step 904 the eNB transmits information indicative of the location of the reserved resources to the UE. The information may include, for example, one or more of:
dynamic location parameters transmitted on the legacy PDCCH as new Downlink Control Information) DCI message in common search space;
dynamic location parameters transmitted on a new physical channel similar to the legacy Physical Control Format Indicator Channel (PCFICH), i.e. enhanced PCFICH (ePCFICH);
semi-static location parameters transmitted via Radio Resource Control (RRC) signaling; and/or
cell ID and/or subframe index information, which may be used by the UE to determine or look up a predetermined location configuration from a table, or similar.

At step 906, the UE receives the transmitted information, and uses it to determine the location(s) of PRB-pairs reserved for ePDCCH allocations. Thereafter, at step 908, the UE is able to access the ePDCCH using the determined location(s).

The discussion will now turn to the design of a suitable ePDCCH search space, and associated blind decoding methods to be implemented in UEs.

According to an emerging consensus, an eCCE is the minimum unit for assigning a DCI on the ePDCCH, and DCI multiplexing for the ePDCCH is based on the eCCE structure. It would be desirable to have eCCE size similar to that of the legacy CCE, i.e. to define the eCCE size to be around 36 Resource Elements (REs), in order to inherit the design of the legacy PDCCH. However, it is not possible to have a common eCCE size or to have the same number of eCCEs in all subframes and PRB-pairs. For example, on a given PRB pair, the number of available REs for ePDCCH transmission can vary significantly depending on factors including:
legacy control region size;
subframe type;
number of Common Reference Signal (CRS) ports;
number of Channel State Information RS (CSI-RS) ports; and
presence of PSS/SSS/PBCH in the PRB.

A search space design, and associated blind decoding method, are therefore required which can operate efficiently in the presence of varying eCCE size, and number of eCCE subframes.

According to exemplary embodiments described here, the ePDCCH is transmitted via an eCCE, or an aggregation of multiple eCCEs, whereby the eCCE is the basic unit of ePDCCH search space construction. The main object of the search space design is to specify procedures for a UE to blindly decode DCIs within the ePDCCH, after construction of composite eCCEs. As previously noted, the following factors are to be considered in defining a suitable ePDCCH search space:
ability to support antenna port association with eCCE index implicitly defined in the specification;
ability to scale with the number of allocated PRB-pairs for ePDCCH transmission;
ability to support a different number of eCCEs within a PRB-pair; and
minimization of blocking probability, and blind decoding complexity.

Furthermore, in embodiments based upon the localized and distributed PRB-pair allocations described above with reference to FIGS. 1 to 9, the search space design principles set out below are applicable for both localized and distributed transmission:
the search space is to be defined based on eCCE;
search space candidate eCCE(s) are not mixed between localized and distributed transmission; and
a UE should be able to monitor both localized and distributed transmission simultaneously.

According to embodiments of this aspect, PRB-pairs for ePDCCH are selected by the eNB and are indicated to UE. The PRB selection and indication procedure may be conducted, for example, as described above with reference to FIGS. 1 to 9. Following the indication procedure, the UE knows the locations of ePDCCH PRB-pairs.

In the following discussion, Mₖ represents the number of ePDCCH PRB-pairs configured in the k-th sub-frame. The value of Mₖ may change from subframe to subframe depending on the resources required for ePDCCH transmission.

Furthermore, according to embodiments, the UE will also know the position of ePDCCH signals received in the subframe, based upon definitions of the enhanced Resource Element Group (eREG) and eCCE set out in the relevant 3GPP specifications. The UE is thus able to form composite eCCEs by extracting the received signals in the corresponding positions of the ePDCCH REs.

The number of candidate location for DCI blind decoding depends on the number of eCCEs per PRB-pair (defined as N_{eCCE}), the number of supported aggregation levels (defined as Lₖ) and the number of ePDCCH PRB-pairs (defined as Mₖ).

Advantageously, according to embodiments, the candidate search space (Sₖ^{(L)}) scales with the number of PRB-pairs allocated for ePDCCH. This provides more flexibility for the network for scheduling and capacity handling. The resulting increased number of blind decoding attempts required by the UE may be limited by 3GPP specifications to a predetermined maximum number of PRB-pairs monitored by a UE. By way of example, Table 5 illustrates the number of search space candidates for a UE configured to monitor 4 PRB-pairs for ePDCCH in a UE-specific search space (USS).

TABLE 5

| | | |
|---|---|---|
| | Number of ePDCCH USS | Number of legacy |
| Aggregation | candidates M^{(L)} | PD CCH USS |

| level L | N [symbol] _{CCE} = 2 | N [symbol] _{CCE} = 4 | candidates M^{(L)} |
|---|---|---|---|
| 1 | 4 | 4 | 6 |
| 2 | 2 | 4 | 6 |
| 4 | 1 | 2 | 2 |
| 8 | N/A | 1 | 2 |
| Total | 7 | 11 | 16 |

[symbol]

indicates data missing or illegible when filed

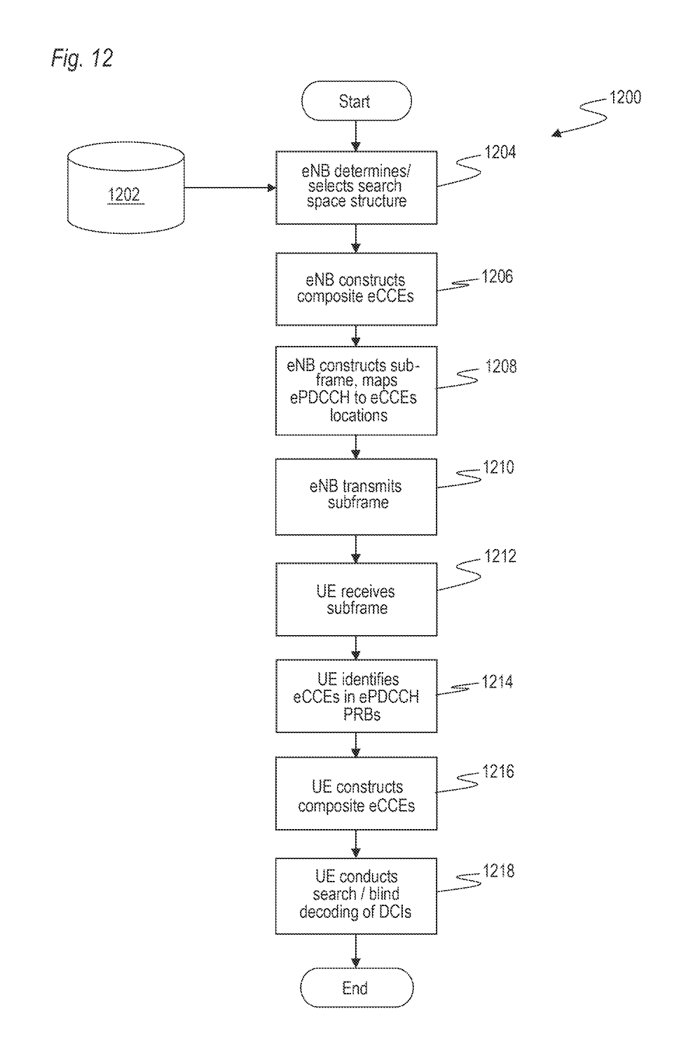

The overall procedures embodying this aspect are further illustrated by the flowchart in FIG. 12.

In particular, the flowchart 1200 illustrates a method as conducted by a wireless base station (i.e. eNB) in communication with a wireless device (i.e. UE). In order to transmit, e.g., scheduling information to the UE via a DCI within the ePDCCH, the eNB must allocate corresponding eCCEs within a search space of the ePDCCH configured for blind decoding by the UE. The eNB of course knows the UE/cell identification (e.g. the relevant RNTI), as well as the subframe index in which the DCI is to be transmitted. It also knows the relevant configuration of the UE and the current state of the radio channel. It is therefore able to determine the corresponding search space within which the DCI should be allocated for correct blind decoding by the UE, e.g. to select the required search space structure from the exemplary structures 1000, 1100.

As indicated in the flowchart 1200, the relevant search space structures and/or parameters defining the search spaces may be stored in a database, table or other record store 1202. Accordingly, at step 1204, the eNB processor determines and selects the appropriate search space information from the record store 1202. The eNB processor then constructs a composite control channel structure (e.g. the composite eCCEs 1010, 1110) at step 1206. In general, the eNB will need to transmit DCIs to a plurality of UEs, and thus the composite eCCEs will typically be populated with a plurality of DCIs directed to one or more UEs within associated search space structures. (For the purposes of the present discussion, we assume that contention/blocking does not occur.)

At step 1208, the eNB processor maps the composite control channel structures (e.g. composite eCCEs) to the allocated resources (e.g. PRB pairs) within the data region of the subframe, resulting in a plurality of control channel structures (e.g. eCCEs) being associated with corresponding resource elements within the subframe.

At step 1210, the subframe, including the ePDCCH including the eCCEs, is transmitted, and at step 1212 it is received by the UE.

At step 1214, the UE processor identifies the received control channel structures (e.g. eCCEs) within the subframe, and at step 1216 the UE processor reconstructs the composite control channel structures (e.g. composite eCCEs). At step 1218, the UE processor determines and selects the appropriate search space information, replicating the process conducted by the eNB when constructing the original composite eCCEs, and then performs blind decoding of the DCI(s) by conducting a search of the selected search space. This will lead to identification of any DCI(s) directed to the UE, which can then be decoded and further relevant actions taken by the UE processor.

It will be understood that the foregoing description of particular embodiments is provided by way of example only, and should not be taken to exclude from within the scope any variations or modifications which may be apparent to the person skilled on the art, or which do not deviate from the general principals as disclosed herein.

For example, in various embodiments, the number of configured ePDCCH resource sets/clusters could be cell-specific or UE-specific, and it may be dependent on system bandwidth and deployment scenarios. In the above described embodiments, one set for localized transmission and one set for distributed transmission are considered to outline the signaling mechanism. However, this could be extended to any number of sets. Further, the signaling contents are advantageously designed to support dynamic PRB allocations to UE for ePDCCH. However, the same signaling contents could be used to indicate PRB allocations semi-statically to UE by RRC signaling.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. It should therefore be understood that the described embodiments are not limiting, and the scope is as defined by the appended claims.

### INCORPORATION BY REFERENCE

This application is based upon and claims the benefit of priority from Australian Provisional Patent Application No. 2012904157, filed on Sep. 24, 2012, the disclosure of which is incorporated herein in its entirety by reference.

### REFERENCE SIGNS LIST

102 eNB
104 UE
112 entity
202 localized allocation scheme
204 contiguous block
206 distributed allocation scheme
210 allocation scheme
212 PRB-pairs
400 HetNet deployment scenario
404 pico-cell
402 macro-cell
406 Almost Blank Subframe (ABS)
408 subframe
410, 412 ePDCCH scheduling windows
1100, 1200 search space candidates
1002, 1004, 1006, 1008, 1102-1108 search spaces

1. A method implemented in a base station used in a wireless communications system, the method comprising:
transmitting, to a user equipment (UE), an indication of a type of enhanced physical downlink control channel (ePDCCH) transmission, where the type of ePDCCH transmission comprises either localized transmission or distributed transmission;
transmitting, to the UE, an indication of the number of physical resource block (PRB) pairs allocated for the ePDCCH transmission, where the indication of the number of PRB pairs allocated for the ePDCCH transmission is conveyed in 2 or 3 bits.

2. The method as in claim 1, wherein the indication of the type of ePDCCH transmission is conveyed in 1 bit.

3. The method as in claim 1, wherein at least one of the indication of the type of ePDCCH transmission and the indication of the number of PRB pairs allocated for the ePDCCH transmission is transmitted in downlink control information (DCI) on a physical downlink control channel (PDCCH).

4. The method as in claim 1, wherein at least one of the indication of the type of ePDCCH transmission and the indication of the number of PRB pairs allocated for the ePDCCH transmission is transmitted on an enhanced physical control format indicator channel (ePCFICH).

5. The method as in claim 1, wherein at least one of the indication of the type of ePDCCH transmission and the indication of the number of PRB pairs allocated for the ePDCCH transmission is transmitted via radio resource control (RRC) signaling.

6. The method as in claim 1, wherein at least one of the indication of the type of ePDCCH transmission and the indication of the number of PRB pairs allocated for the ePDCCH transmission is dynamically indicated from subframe to subframe.

7. A method implemented in a user equipment (UE) used in a wireless communications system, the method comprising:
receiving, from a base station, an indication of a type of enhanced physical downlink control channel (ePDCCH) transmission, where the type of ePDCCH transmission comprises either localized transmission or distributed transmission;
receiving, from the base station, an indication of the number of physical resource block (PRB) pairs allocated for the ePDCCH transmission, where the indication of the number of PRB pairs allocated for the ePDCCH transmission is conveyed in 2 or 3 bits.

8. A method implemented in a wireless communications system, the method comprising:
transmitting, from a base station to a user equipment (UE), an indication of a type of enhanced physical downlink control channel (ePDCCH) transmission, where the type of ePDCCH transmission comprises either localized transmission or distributed transmission;
transmitting, from the base station to the UE, an indication of the number of physical resource block (PRB) pairs allocated for the ePDCCH transmission, where the indication of the number of PRB pairs allocated for the ePDCCH transmission is conveyed in 2 or 3 bits.

9. A base station used in a wireless communications system, the base station comprising:
a transmitter to transmit to a user equipment (UE) an indication of a type of enhanced physical downlink control channel (ePDCCH) transmission, and an indication of the number of physical resource block (PRB) pairs allocated for the ePDCCH transmission,
wherein the type of ePDCCH transmission comprises either localized transmission or distributed transmission, and
wherein the indication of the number of PRB pairs allocated for the ePDCCH transmission is conveyed in 2 or 3 bits.

10. A user equipment (UE) used in a wireless communications system, the UE comprising:
a receiver to receive from a base station an indication of a type of enhanced physical downlink control channel (ePDCCH) transmission, and an indication of the number of physical resource block (PRB) pairs allocated for the ePDCCH transmission,
wherein the type of ePDCCH transmission comprises either localized transmission or distributed transmission, and
wherein the indication of the number of PRB pairs allocated for the ePDCCH transmission is conveyed in 2 or 3 bits.

11. A wireless communications system comprising:
a base station to transmit an indication of a type of enhanced physical downlink control channel (ePDCCH) transmission, and an indication of the number of physical resource block (PRB) pairs allocated for the ePDCCH transmission; and
a user equipment (UE) to receive the indication of the type of ePDCCH transmission and the indication of the number of PRB pairs allocated for the ePDCCH transmission,
wherein the type of ePDCCH transmission comprises either localized transmission or distributed transmission, and
wherein the indication of the number of PRB pairs allocated for the ePDCCH transmission is conveyed in 2 or 3 bits.

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)
